(19) United States
(12) Patent Application Publication
(10) Pub. No.: US 2007/0209012 A1
(43) Pub. Date: Sep. 6, 2007

(54) Engine 3D by layer 2D

(76) Inventor: Patrick Mazery, Paris (FR)

Correspondence Address: MAZERY, 3 rue BUDE, PARIS, 75004, FR

(21) Appl. No.: 11/728,281

(22) Filed: Mar. 26, 2007

(30) Foreign Application Priority Data
Nov. 4, 2005 (FR) PCT/FR05/02743
Nov. 9, 2004 (FR) FR/0411940

(51) Int. Cl. G06T 15/00; G06F 17/00; G06F 3/048

(52) U.S. Cl. 715/763; 345/419; 707/104.1

(57) ABSTRACT

The present invention relates to a navigation and search engine on data bases of speakers (I) pertaining to a landscape (P), the lines of data characterizing the speakers (I) comprising a field of address (Ca) of the speakers (I) in the landscape (P) as well as a series of fields of description (Ci) of the speakers (I) characterized in that it comprises an interface of visualization 3D which represents the landscape (P) starting from a discontinuous limited series of topographic surfaces (Si) with a navigation user 2D confined on each topographic surface (Si) and a filter of representation of the speakers (I) according to their address (Ca) in the landscape (P) which is actuated by the request of the user according to criteria's corresponding to the fields of description (Ci).

The present invention relates to a sophisticated device of geo localization of data and its user interface. It applies to targeted research and/or the iterative and/or random search of addresses, people or services. The device proposing several grids of analysis of data allowing a research according to several criteria. The device proposing a navigation engine and its sophisticated user interface in a field of localization data.

### BACKGROUND OF THE INVENTION

There are several types of navigation engine in a field of localization data. There is for example the device GPS which indicates its position to the user. The GPS which can also show the way between two positions. The defect of the GPS is that the user must imperatively know his destination. The user cannot move on the basis of general idea of its destination, without precise object. The user interfaces on GPS being rather rudimentary and not very intuitive. There are also directories of data, papers or electronic. A defect of these directories is also that the user must have a priori a precise idea of his research. It seeks for example a craftsman electrician in such city, or such area or department. If the user chooses for basic criterion a city it is then limited in his base of answers, if it chooses the area it has evil to position the answers and must carry out a stage of additional work to locate the craftsman more adapted. There are also devices of geo localization, for example by mobile service of telephony, giving to the user the answers closest according to a criterion selected to the place, therefore terminal of emission in the perimeter of which he is. The defect of these devices is that the user interface is often far from practical, being satisfied to enumerate a list of name and address, which for the user is finally rather little speaking and requires an additional stage of interpretation. There is also a device of geo localization by cartography, paper or electronics. Charts being plane, 2D. the user carrying out of macro or the reductions of the chart to widen or refine the prospect. The user also who can question a data base which positions the answer on a chart. A defect of these devices is that they require them also a series of stages of interpretation rather not very intuitive for the user. These devices not allowing an iterative or random research, i.e. which consists in being able to choose and modify the criteria of postings of information, allowing the user to immediately view the position of the places corresponding to its updated criterion of selection.

The whole of the solutions of the former art present many defects of ergonomics and data management which the invention solves.

### BRIEF DESCRIPTION OF THE INVENTION

A principal object of the invention is to propose a device of geo localization of data of localization which is practical and ergonomic and intuitive.

Another principal object of the invention is that the data of localization belong to a field of data. The research of the user whom can be carried out according to one of the unspecified data belonging to the field of data. The device being thus complete and being able to answer an evolutionary request of the user. The user thus who can for example say 1) I seek a craftsman in such zone 2) I find it easily 3) I can then see all the activities of proximity which interest me 4) thanks to the engine of data, I determine a way and I identify several tradesmen who are possibly interesting to discover on the way of return towards at home 5) I visualize this way and all his stops.

An object of the invention is to propose a search for information in visual mode adapted to a general public use.

An object of the invention is to propose computer equipment or electronic presenting a user interface which is convivial and which has levels of varied information according to the level of research of the user and the accuracy of the results that it asks.

An object of the invention is to propose an evolutionary design which adapts to the comprehension of the user. The invention also proposing a navigation on the field of data which is it also simple and intuitive. The invention proposing a dynamic treatment of information with coloured information, of flexible configuration. The invention proposing a tool of decision-making aid which integrates a specific data base or which takes again a base of existing data especially arranged in order to offer an organization compatible with its principle of analysis of geo localization, thus offering to the user a tool of decision-making aid in real time with refreshing of information, according to alternatives' taking account of the real situations.

An object of the invention is to adapt to various supports, which are computers, terminals large public on the spot of visit, or mobile telephones.

An object of the invention is to be able to propose a device of geo localization to users who did not have the use of it hitherto. It can as well be a question of hotel which indicates way practices on its site the addresses useful to its customers around her hotel, or even of a station which indicates by means of a public terminal the addresses useful to its users. The invention thus having to answer a multitude of requests according to several different criteria.

In a principal aspect the invention presents a user interface on an electronic screen of a computer or a terminal or a mobile telephone. This interface represents initially a sight of the space which the user wishes to visit, around this sight various buttons of access to the manager of the data base are positioned. The user initially who can sail in the sight, according to his position in the sight it is well informed on the data on which it points, the user then who can question the data bases and its answer to obtain a specific sight.

In an aspect of the invention the user will sail by layer 2D with an engine of navigation 3D. The interest is that the sight 3D of a plan 2D gives a vision much more intuitive to the user while relieving the stresses of navigation which are complex in 3D. In this form the user having only to move three axes i.e., left, right-hand side and depth for displacement, while in 3D the user must learn how to control 4 axes which are left, right, high and depth for displacement.

In an aspect of the invention the data of geo localization of the fields of data are represented in space of visualization by 3D patterns. These patterns being able for example to take the shape of sticks or beacons, these sticks or beacons presenting a particular aspect according to the family to which they belong, example: blue sticks for the restaurants and of the red sticks for the cinemas. A user will be able to make his research for one evening with like search criterion: cinema+restaurant, it will then see appearing in a very intuitive way a unit of blue and red vertical sticks of color on a plan in prospect.

In an aspect of the invention the user sails by layer 2D. Each layer representing a different level of information.

In an aspect of the invention, the user reaches with a simple click of mouse on the information which it wishes to obtain. Indeed, while pointing on a beacon, it then obtains directly the whole of information which it wishes. It thus is well understood that the invention makes it possible to the user to sail according to various principles, i.e., either by questioning the data bases, or while pointing and or while clicking on beacons or specific interfaces. Navigation being thus according to a particular aspect very complete and rich and according to another extremely simple and fast.

### BRIEF DESCRIPTION OF THE SEVERAL VIEW OF THE DRAWINGS

Other goals, characteristics and advantages of this invention will more clearly arise from the description which follows of an example of realization given on a purely illustrative basis, in reference to the annexed drawings on which:

FIG. 1 represents a data base and its various fields according to the invention

FIG. 2 represents an example landscape sight and its topographic projection

FIG. 3 represents a principle sight of various topographic surfaces

FIG. 4 represents a sight of the user interface according to a first search criterion

FIG. 5 represents a sight of the user interface according to a second search criterion

FIG. 6 represents a sight of the user interface in a median mode

FIG. 7 represents a sight of the user interface in a brought closer mode

FIG. 8 represents a sight of the user interface in a median mode after a displacement of navigation of the user since the sight of FIG. 7.

### DETAILED DESCRIPTION OF THE INVENTION

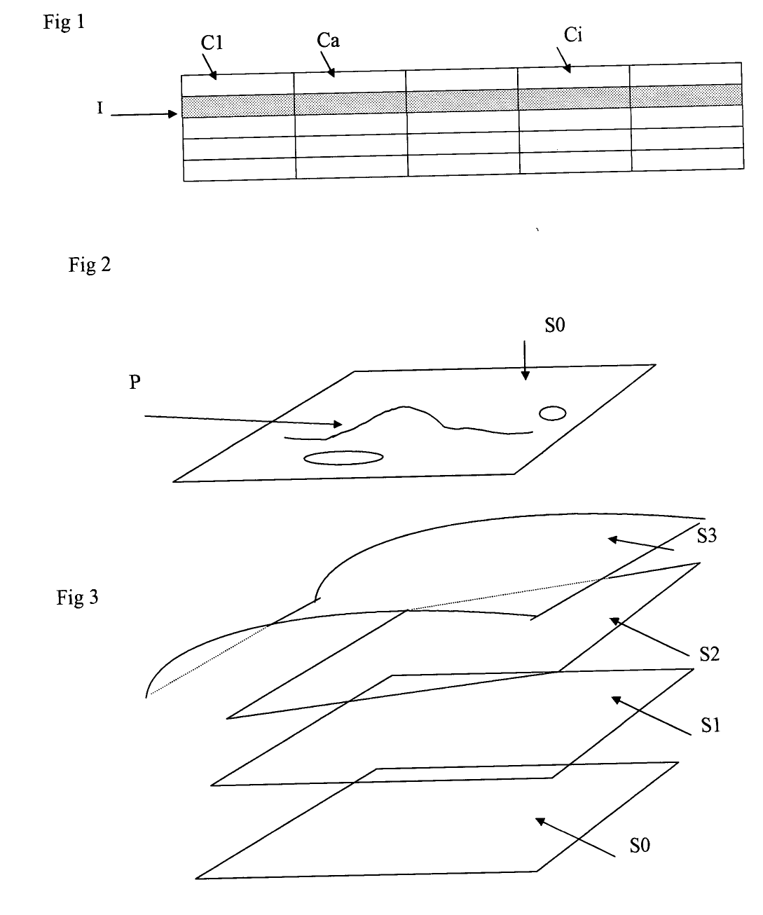

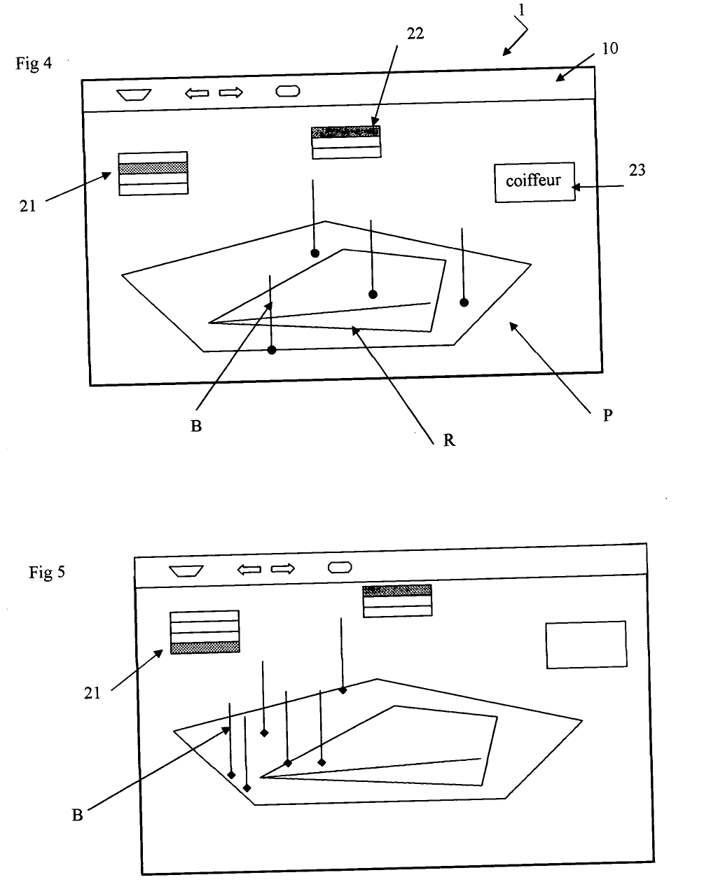

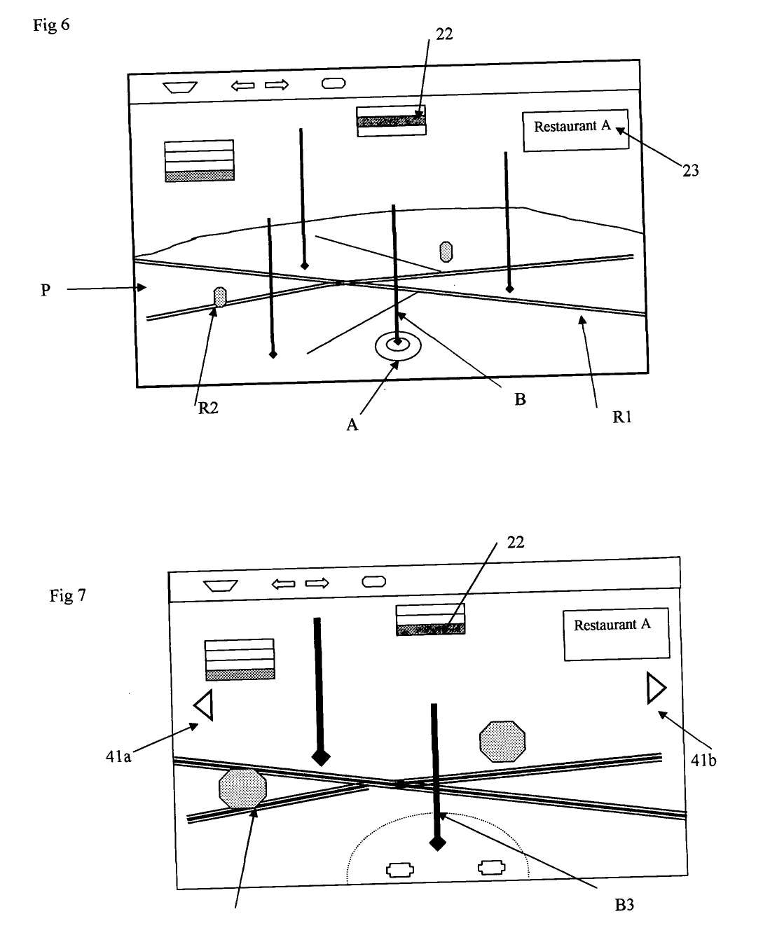

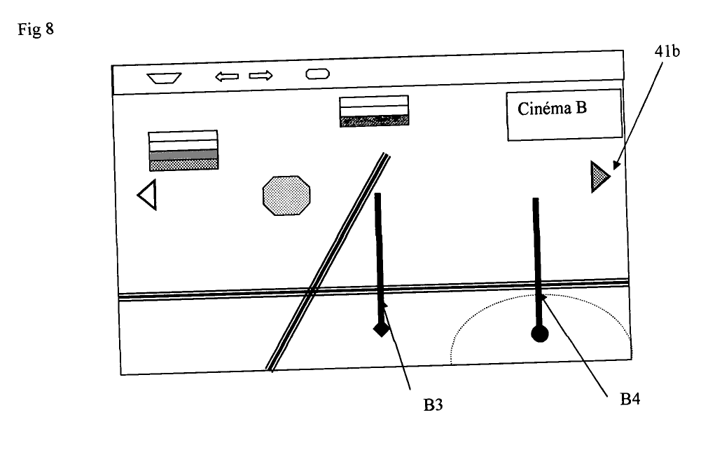

FIG. 1 represents a data base and its various fields (Ci) describing each speaker (I). A speaker will be materialized by a field (C1) of name, by a field (Ca) of address, by a series of characterizing field descriptions (Ci). A characteristic of the invention is to use data bases with a number of speakers (I) reasonable and with a description of activity (Ci) of the speaker which is denser and is treated more on a hierarchical basis than that of the traditional directories. As an example, under a generic heading gastronomy will appear the activities of restoration or delicatessen or suppliers. FIG. 2 represents an example of sight of landscape (P) and its topographic projection (S0) according to a plan in this example. FIG. 2 being able for example represented the town of Paris in plan with Montmartre which is projected on the plan. While according to the invention, the landscapes real (P) in which live the speakers (I) will preferentially be projected on a plan or a topographic surface, and this for reasons of navigation which will clarify us later on. The monuments or elements of landscape could them be modelled in three dimensions. This is explained by the fact that with the invention the user sails with two orders, a first ordering of rotation and a second pitch control order to advance or move back. These displacements being limited and conscript to a topographic surface (Si). The surface simplest to often model being for the graphic designer a simple plan (S0) on which it poses monuments. FIG. 3 represents a sight of principle of various topographic surfaces of catch of sight according to the invention. It includes for example, the first topographic surface of projection of landscape (S0), and in a preferential mode three surfaces from point of view of navigation user (S1, S2, S3). Topographic surfaces of catch of sight (S1, S2, S3) being positioned ones with the top of the others. The first surface from point of view of proximity (S1) being for example a plan parallel at the surface of landscape (S0) slightly on high. In certain cases, these two plans (S0) and (S1) being even confused. The second surface (S2) of median sight being able for example to be it also a plan, which is not inevitably parallel to the plan of proximity (S1). The last surface of broad plan (S3) being able to be a topographic surface curves adopting an ellipsoidal form which will allow a navigation in broad plan which gives better account of certain ratios of distance on the landscape (P). Median topographic surfaces (S2) and remote (S3) being conceived in order to answer the most intuitive and effective vision for the comprehension of the user. FIG. 4 represents a sight of the user interface (1) in a broad mode according to a surface of navigation and catch of sight (S3). Actuation in broad plan is in particular visible by the choice to actuate the broad function plan using the selector knobs of plans (22). In this figure the landscape (P) is represented symbolically with a series of details (R) like streets or monuments taking again the elements characteristic of the landscape (P). According to this figure the user carried out a filter (21) according to a first search criterion which launched to him the posting of all the speakers (I) present in the landscape (P) and answering the criteria of the filter (21). The speakers (I) being materialized by beacons (B) perpendicular to the surface of representation (S0) of the landscape (P). This form of representation allowing the user at the same time to have a panoramic sight of the landscape while identifying easily the beacons (B) and their position in the landscape. The beacons (B) presenting a different aspect, for example by their color, if they are selected according to a criterion or of another, for example according to the gastronomy criterion or the cinema criterion. FIG. 5 represents a sight of the user interface in a broad mode according to a second search criterion with a new filter of research (21) and thus with a new selection of beacons (B) presenting at the same time a positioning and an aspect different from that of FIG. 4. On FIG. 4 is also represented a second filter of representation through language (23) beacons (B) which answers him at a request in direct question coming from the user. This interface can also be selected to post information spontaneously when the beacons are active, FIG. 6. The traditional bar of task (10) makes it possible to leave towards another functionality. FIG. 6 represents a sight of the user interface in a median mode according to the second topographic surface (S2). To pass from the broad mode (S3) to the median mode (S2), the user can either choice to act on the function of selection of plan (22) or to activate (A) a beacon (B) while clicking above by means of his mouse. Activation (A) of the beacon reveals on the screen of interface beacon information characteristic of the speaker (I). The median level (S2) revealing a new level of detail (R1, R2) with a closer sight on the landscape (P). FIG. 7 represents a sight of the user interface in a closer mode (S1). For example, on FIG. 7 appear buttons of navigation (41a, 41b) for left right rotation. Depth, for example being obtained by means of the mouse. A beacon of the restoring type (B3) is active. FIG. 8 represents a sight of the user interface in a median mode after a displacement of navigation of the user since the sight of FIG. 7. In this case a new beacon of the type cinema (B4) is active. The user who can at the same time sail by means of the buttons of navigation and also through moving from beacons (B3) to beacons (B4). The invention enabling a user can to record his way and to print it according to the level of precision which it wishes (S1, S2, S3).

The invention thus relates to a navigation and search engine on data bases of speakers (I) in a landscape (P), the lines of data characterizing the speakers (I) comprising a field of co-ordinates of address (Ca) of the speakers (I) in the landscape (P) as well as a series of fields of description (Ci) of the speakers (I) characterized in that it comprises an interface of visualization 3D user (1) which represents the landscape (P) starting from a discontinuous limited series of topographic surfaces of catches of sights (Si) with a navigation user 2D confined on each topographic surface of catch of sight (Si) and a filter of representation (21,23) of the speakers (I) represented by a symbol (B) at their address (Ca) in the landscape (P) on the user interface (1) which is actuated by the request of the user on the filter of representation (21,23) according to criteria's corresponding to the fields of description (Ci).

The invention thus relates to a navigation and search engine on data bases characterized in that the speaker (I) is materialized on the user interface by a symbol (B) positioned on topographic surface (S0) but not registered in surface (S0).

The invention thus relates to a navigation and search engine on data bases characterized in that the conventional signs (B) of the speakers (I) are beacons or sticks appreciably perpendicular to the surface of projection (S0) of the landscape (P)

The invention thus relates to a navigation and search engine on data bases characterized in that the beacons of representation (B) of the speakers (I) adopt a color or a specific form according to the contents of the descriptive fields (Ci) active through the filters of representation (21,23).

The invention thus relates to a navigation and search engine on data bases characterized in that topographic surfaces of catch of sight (S1, S2, S3) are plans.

The invention thus relates to a navigation and search engine on data bases characterized in that navigation is as well activated by the action on the filters (21,23) that on the buttons of navigation (41) that on the beacons (B).

The invention thus relates to a navigation and search engine on data bases characterized in that the characteristics and the rules of navigation are different according to topographic surfaces' from catch of sight (S1, S2, S3).

One thus sees well that many alternatives possibly suitable for combine can be brought here without never leaving the framework of the invention such as it is defined below.

What I claim as my invention is:

1- Navigation and search engine on data bases of speakers (I) in a landscape (P), lines of data characterizing the speakers (I) comprising a field of address (Ca) of the speakers (I) in the landscape (P) as well as a series of fields of description (Ci) of the speakers (I) characterized in that it comprises an interface of visualization 3D user (1) which represents the landscape (P) starting from a discontinuous limited series of topographic surfaces of catches of sights (Si) with a navigation user 2D confined on each topographic surface of catch of sight (Si) and a filter of representation (21,23) of the speakers (I) represented by a pictogram (B) at their address (Ca) in the landscape (P) on the user interface (1) which is actuated by the request of the user on the filter of representation (21,23) according to criteria's corresponding to the fields of description (Ci).

2- Navigation and search engine on data bases according to claim 1 characterized in that the speaker (I) is materialized on the user interface by a pictogram (B) positioned on topographic surface (S0) representing real topography but not registered in surface (S0), to be reached with the intersection by navigation in surfaces of catches of sights (Si).

3- Navigation and search engine on data bases according to claim 2 characterized in that the pictograms (B) of the speakers (I) comprise a principal axis perpendicular to the surface of projection (S0) of the landscape (P).

4- Navigation and search engine on data bases according to claim 3 characterized in that the pictograms (B) of the speakers (I) are activated by modification of color or form according to the contents of the descriptive fields (Ci) active through the filters of representation (21,23) and according to the position of navigation on the topographic surface of catch of sight (Si).

5- Navigation and search engine on data bases according to claim 1 characterized in that topographic surfaces of catch of sight (S1, S2, S3) are plans.

6- Navigation and search engine on data bases according to claim 1 characterized in that navigation is as well activated by the action on the filters (21,23) that on the buttons of navigation (41) that on the beacons (B).

7- Navigation and search engine on data bases according to claim 1 characterized in that the characteristics and the rules of navigation are different according to topographic surfaces' from catch of sight (S1, S2, S3)

8- Navigation and search engine on data bases according to claim 1 characterized in that jumps of navigation of the first topographic surface of catch of sight (Si) on the one second topographic surface of catch of sight (Si) are carried out by the actuation of a pictogram (B).

9- Navigation and search engine on data bases according to claim 1 characterized in that navigation on topographic surface (S0) is incremental by actuating the pictograms (Bi) in order to adopt the point of view obtained by the user from each one of these pictograms (Bi) and reading the criteria corresponding to the fields of description (Ci) of the line of data (C) characterizing the speaker (II) represented by the pictogram (Bi).
